(19) United States
(12) Patent Application Publication
(10) Pub. No.: US 2025/0346530 A1
(43) Pub. Date: Nov. 13, 2025

(54) Concrete Flooring System And Method Of Installation Thereof

(71) Applicant: All Construction Solutions Inc., St. Albert (CA)

(72) Inventor: Morris Kadylo, St. Albert (CA)

(21) Appl. No.: 19/202,158

(22) Filed: May 8, 2025

Related U.S. Application Data
(60) Provisional application No. 63/645,310, filed on May 10, 2024.

(51) Int. Cl. C04B 20/00; C04B 16/04; C04B 103/00; C04B 103/14; C04B 103/32; C04B 111/00

(52) U.S. Cl. CPC C04B 20/006; C04B 16/04; C04B 2103/0079; C04B 2103/14; C04B 2103/32; C04B 2111/00068; C04B 2201/50

(57) ABSTRACT

A concrete flooring base layer includes a concrete mixture having an aggregate, microfibres, a plasticizer, and a densifier or hardener, and is absent of water. A method of installing a concrete flooring base layer includes applying a first layer of sealer to a sub-floor upon which the base layer will be applied to prevent moisture from being absorbed into the sub-floor, applying a concrete mixture in a layer over the sealer, manually leveling and layering the concrete mixture layer, and applying a second layer of sealer overtop of the concrete mix layer to prevent evaporation of moisture from the concrete layer, thereby reducing chances of shrinkage and cracking.

### FIELD OF THE INVENTION

The present disclosure relates to concrete flooring and methods of manufacture and installation of such concrete flooring.

### BACKGROUND OF THE INVENTION

Amongst many types of bases or underlayment for industrial, commercial and residential flooring, gypsum is often a popular choice. Gypsum based underlayment has been found to be relatively simple to install and suitable as a base under a variety of floor coverings.

Gypsum-based compounds have been found to be substantially stress-free and show good strength, in the range of 25 to 35 N/mm².

However, recently there has been a significant shortage of gypsum raw materials and with increased demand, a shortage of gypsum-based flooring supply in the construction industry. This has inevitably led to a sharp increase in pricing of the material and construction delays in the wait for gypsum-based material to become available.

Some attempts have been made to fill the void in gypsum-based flooring materials with concrete-based underlayment and bases, however these come with a number of disadvantages. Concrete flooring compounds are heavy and add undue weight to the flooring system. Concrete has traditionally required a greater thickness of application than gypsum and also has a tendency to shrink during setting and can build up relatively high stresses combined with a pronounced tendency to cracking.

Traditional concrete mixes are preferred to be made with a high degree of fluidity, also known as slump. Slump is measured in millimeters and is defined by a well-known slump test. For flooring purposes, and to enhance self-levelling, concretes with high slump values, or high fluidity are used, as they take little manual leveling and smoothing.

A need exists in the art for underlayment and flooring bases that are not gypsum-based, but which show good strength and with reduced tendency to crack.

### SUMMARY OF THE INVENTION

A concrete flooring base layer comprising a concrete mixture comprising: an aggregate; microfibres; a plasticizer; and a densifier or hardener. The concrete mixture is absent of water.

A method of installing a concrete flooring base layer. The method comprises the steps of:
a. applying a first layer of sealer to a sub-floor upon which the base layer will be applied, said first sealer layer serving to prevent moisture from being absorbed into the sub-floor;
b. applying a concrete mixture, in a layer over the sealer, wherein said layer has a thickness of between 1″ and 4″;
c. manually leveling and layering the concrete mixture layer; and
d. applying a second layer of sealer overtop of the concrete mix layer, said second sealer layer serving to prevent evaporation of moisture from the concrete layer, thereby reducing chances of shrinkage and cracking.

### BRIEF DESCRIPTION OF THE DRAWINGS

A further, detailed description of the disclosure, briefly described above, will follow by reference to the following drawings of specific embodiments of the disclosure. The drawings depict only typical embodiments of the disclosure and are therefore not to be considered limiting of its scope. In the drawings:

FIG. 1 is cross sectional elevation diagram of one embodiment of a flooring system of the present disclosure.

The drawings are not necessarily to scale and, in some instances, proportions may have been exaggerated in order to more clearly depict certain features.

### DETAILED DESCRIPTION OF THE PREFERRED EMBODIMENTS

The description that follows and the embodiments described therein are provided by way of illustration of an example, or examples, of particular embodiments of the principles of various aspects of the present disclosure. These examples are provided for the purposes of explanation, and not of limitation, of those principles and of the disclosure in its various aspects.

The present disclosure provides an underlayment or flooring base made from concrete rather than from gypsum-based materials. The present concrete flooring base provides sufficient strength for floor-supporting purposes and they installation method serves to minimize and eliminate cracking. Unlike prior art attempts at concrete flooring, the present inventors have found that the present concrete flooring base can be applied in a thickness of as little as 1.5″ (38 mm) while still providing strength for flooring purposes.

Unlike traditional gypsum-based mixes that are made with a high degree of fluidity and higher slump values of up to 800 to 900 mm, the present concrete mix is installed at a much lower slump value of between 200 mm and 300 mm, and more preferably from 220 to 260 mm of slump. This provides less fluidity and may require more manual spreading and levelling but has shown the markedly improved crack reduction/elimination and strength over predecessor concrete flooring product.

The present concrete floor base is preferably a mix of an aggregate and microfibres together with a plasticizer, densifier or hardener. Preferably no water is added to the mix to avoid excess of moisture which can seep into sub-floors or evaporate and cause potential shrinkage or cracking. Preferably the plasticizer is a superplasticizer.

The aggregate is preferably a 10 mm aggregate. The content of the microfibre in the present concrete mix is preferably about 1.2 kg/m³. The presence of microfibres in the present concrete mix serve a number of purposes including holding the final mix together even when applied at thinner layers and reducing or eliminating cracking of the final dried concrete flooring base layer.

The concrete mix, when finished preferably has an air content of between 0-3% air by volume, which is industry classified as a non-air mixture. Optionally, a bonding agent may be added.

The present concrete mix has been tested to show a minimum strength of 20 MPa. The present concrete mix can weigh up to 18.8 pounds per square foot (lb/sf) which is higher than the weight of gypsum-based flooring bases, but the weight is still within engineering limits for construction projects and meets current codes. Styrene pellets can be added to the concrete mixture to reduce the weight of the concrete mixture, down to about 13.8 lb/sf. Preferably a content of styrene pellets within the concrete mixture meets a ratio of 1 m³ of styrene pellets to 3 m³ of total concrete mixture.

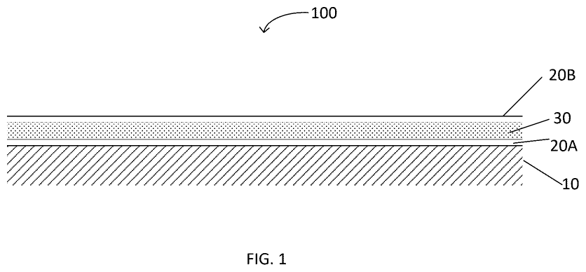

With reference to FIG. 1 a system 100 of the present disclosure is described. The present concrete mix can be applied to conventional sub-floor 10 surfaces. The sub-floor 10 can be of any type including plywood, oriented strand board or particle board. In an initial step of the present method, a sealer 20A is applied to the sub-floor 10. The sealer prevents moisture from being absorbed and pulled into the sub-floor 10. The concrete mixture is applied in a layer 30 over the sealer 20A a conventional means on top of the sealer 20A. The layer 30 is commonly 1.5″ thick, no less than 1″ thick and can be up to 3″ thick. The product can be used in a thickness of anywhere between 1″ to 4″ thick.

Finishing and leveling of the concrete mix layer 30 is done manually by up to 8-10 man-crew of members depending on application size and surface area. The finishing and leveling can be done with conventional manual tools including finishing with screeds, trowels, floats and possibly walkers, a larger, 36-48″ mechanical trowel, if required, to obtain level finish.

Since the present concrete mix has a lower fluidity and slump than traditional gypsum-based mix, it does not as readily self-level. However, with a lower moisture level, and due to presence of microfibres in the mix, there is a minimized chance of shrinkage due to loss of moisture. Minimizing shrinkage also ensures minimal to no cracking in the final concrete layer 30.

A second layer of sealer 20B is then applied on top of the concrete mix layer 30. The upper sealer layer 20B serves to reduce or prevent evaporation of moisture out of the concrete layer, thereby reducing chances of shrinkage and cracking.

In an optional embodiment, in-floor heating lines (not shown) can be installed on the sub-floor 10 before application of the concrete mix layer 30.

Various floor assemblies are possible with the present system 100, including options with optionally additional insulation, resilient channels for sound proofing, and optional layers of drywall.

The previous description of the disclosed embodiments is provided to enable any person skilled in the art to make or use the present disclosure. Various modifications to those embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims.

What is claimed:

1. A concrete flooring base layer comprising a concrete mixture comprising:
an aggregate;
microfibres;
a plasticizer; and
a densifier or hardener,
wherein the concrete mixture is absent of water.

2. The concrete flooring base layer of claim 1, wherein the plasticizer is a superplasticizer.

3. The concrete flooring base layer of claim 1, wherein aggregate is a 10 mm aggregate.

4. The concrete flooring base layer of claim 1, wherein a content of the microfibre in the concrete mix is 1.2 kg/m³.

5. The concrete flooring base layer of claim 4, wherein microfibres serve to hold the concrete mixture together such that a thickness of the base layer can be minimized, and to reduce cracking during drying of the concrete flooring base layer.

6. The concrete flooring base layer of claim 5, wherein the base layer has a thickness of between 1″ and 4″.

7. The concrete flooring base layer of claim 5, wherein the base layer has a thickness of 1.5″.

8. The concrete flooring base layer of claim 1, wherein the base layer has an air content of between 0% and 3% air by volume.

9. The concrete flooring base layer of claim 1, wherein the concrete mixture further comprises a bonding agent.

10. The concrete flooring base layer of claim 1, wherein having a minimum strength of 20 MPa.

11. The concrete flooring base layer of claim 1, wherein have a weight of up to 18.8 pounds per square foot.

12. The concrete flooring base layer of claim 1, wherein the concrete mixture further comprises styrene pellets to reduce the weight of the base layer to up to 13.8 pounds per square foot.

13. The concrete flooring base layer of claim 12, wherein a content of styrene pellets within the concrete mixture meets a ratio of 1 m³ of styrene pellets to 3 m³ of total concrete mixture.

14. The concrete base layer of claim 1, wherein present concrete mix has a slump value of between 200 mm and 300 mm.

15. The concrete base layer of claim 1, wherein the present concrete mix has a slump value of from 220 to 260 mm.

16. A method of installing a concrete flooring base layer, said method comprising the steps of:
applying a first layer of sealer to a sub-floor upon which the base layer will be applied, said first sealer layer serving to prevent moisture from being absorbed into the sub-floor;
applying the concrete mixture of claim 1, in a layer over the sealer, wherein said layer has a thickness of between 1″ and 4″;
manually leveling and layering the concrete mixture layer; and
applying a second layer of sealer overtop of the concrete mix layer, said second sealer layer serving to prevent evaporation of moisture from the concrete layer, thereby reducing chances of shrinkage and cracking.

17. The method of claim 16, further comprising a step of installing in-floor heating lines on the sub-floor prior to application of the concrete mix layer.

18. The method of claim 16, wherein the sub-floor comprises plywood, oriented strand board or particle board.
